(19) United States
(12) Patent Application Publication
(10) Pub. No.: US 2005/0062644 A1
(43) Pub. Date: Mar. 24, 2005

(54) Capsule device to identify the location of an individual

(76) Inventor: Jonathan Ilan Leci, Jerusalem (IL)

Correspondence Address: JONATHAN ILAN LECI, BRENER ST 4/4, JERUSALEM, 92106, IL

(21) Appl. No.: 10/656,104

(22) Filed: Sep. 8, 2003

(51) Int. Cl. G01S 5/14

(52) U.S. Cl. 342/357.07; 342/465

(57) ABSTRACT

A capsule device that will contain a transmitter and power unit that will emit a location/distress signal using satellite or other communication system. After being swallowed, the capsule device will emit a signal identifying the location of the individual, without enemy forces being aware that such a signal is being emitted.

### BACKGROUND

The present invention relates to a capsule device to save lives, and particularly to a capsule device that is able to emit a location/distress signal via a Global Positioning System transmitter, GALILEO satellite radio navigation system transmitter or other transmitter from inside the human body that is activated by a sensor.

There are today systems that can identify the location of an individual using GPS and other equipment, however, in a situation where one is in distress, captured or lost and one does not have their belongings and equipment with them (since they got lost or were removed by force) one will still be able to issue a distress signal by having swallowed the capsule device and issue a signal from inside the human body. This will prevent an enemy force knowing that a distress/location signal is being issued and will enable a rescue operation to be mounted with high precision. This capsule device, once in the human body, will be protected from external forces unlike the current external distress/location signal that is exposed and may be damaged by natural forces.

In light of the widely recognized need of an individual to be able to issue a location/distress signal that an enemy force is not aware is being issued, and in light of the need to protect this type of equipment, it would be highly advantageous to have a location/distress signal being emitted from within a capsule device in the human body. Many additional benefits of the method disclosed will become apparent in the disclosure below.

### SUMMARY

According to the present invention there is provided a capsule device that will contain a transmitter and a power unit. The capsule device will be swallowed into the human body, and a transmitter will emit a location/distress signal. This signal will give the location of the individual. The transmitter will use one or more of the following transmitter systems: a Global Positioning System, GALILEO satellite radio navigation system, a satellite system, a radio system, Wi-Fi transmitter system or other transmission system that is built into the capsule.

According to further features in preferred embodiments of the invention described below, a sensor will be added to the capsule that will activate the transmitter. This sensor will be activated in one or more ways including contact with alkaline in the human body, contact with acid in the human body, contact with saliva in the human body, contact with blood in the human body, contact with water by air pressure or by the inflation of an item.

The present invention successfully addresses the shortcomings of the presently known configurations by providing the ability to emit a location/distress signal from a capsule inside the human body, without the enemy being aware that a signal is being emitted.

### BRIEF DESCRIPTION OF THE DRAWINGS

The invention is herein described, by way of example only, with reference to the accompanying drawings, wherein:

FIG. 1 is a diagram of the capsule casing.

FIG. 2 is a diagram of the transmitter.

FIG. 3 is a diagram of the power unit.

### DESCRIPTION OF THE PREFERRED EMBODIMENTS

The present invention has the ability to emit a location/distress signal. The present disclosure relates particularly to the individual being able to issue a location/distress signal and more particularly, to issue a location/distress signal from within the human body using a transmission system based on one or more of the following transmission systems including a Global Positioning System, GALILEO satellite radio navigation system, satellite system, a radio system, Wi-Fi transmitter system or other transmission system that is built into a capsule.

An additional preferred embodiment is a sensor. This sensor will be activated in a number of ways including contact with alkaline in the human body, contact with acid in the human body, contact with saliva in the human body, contact with blood in the human body, contact with water or by air pressure or by inflation of an item. In addition, many modifications and variations on the transmission system, capsule and sensor are possible as well.

Specifically, the present invention can be used to issue a signal identifying the location of an individual.

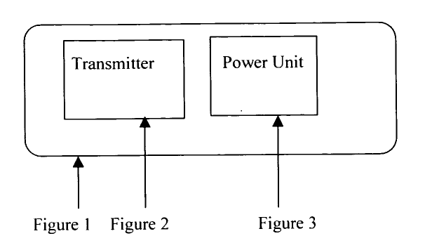

Referring now to the drawings, FIG. 1 illustrates the capsule device. Travel through the human body is facilitated by casing that encloses and protects the transmitter and power unit. FIG. 2 is the transmitter that will issue the distress signal identifying the location of the individual and FIG. 3 is the power unit that will supply the energy to the transmitter.

While the invention has been described with respect to a limited number of embodiments, it will be appreciated that many variations, modifications and other applications of the invention may be made.

1. A capsule device comprising a transmitter and a power unit, disposed in a swallowable digestive capsule, wherein said transmitter is adapted to transmit a distress/location signal from inside a human body.

2. The capsule device of claim 1, further comprising a sensor device.

3. The capsule device of claim 1, wherein the transmitter is a radio transmitter.

4. The capsule device of claim 1, wherein the transmitter is a Global Positioning System transmitter.

5. The capsule device of claim 1, wherein the transmitter is a GALILEO satellite radio navigation system transmitter.

6. The capsule device of claim 1, wherein the transmitter is a satellite transmitter

7. The capsule device of claim 1, wherein the transmitter is a Wi-Fi transmitter.

8. The sensor device of claim 2, wherein the sensor is activated by contact with the alkaline in the human body.

9. The sensor device of claim 2, wherein the sensor is activated by contact with the acid in the human body.

10. The sensor device of claim 2, wherein the sensor is activated by contact with the saliva in the human body.

11. The sensor device of claim 2, wherein the sensor is activated by contact with the blood in the human body.

12. The sensor device of claim 2, wherein the sensor is activated by contact with water.

13. The sensor device of claim 2, wherein the sensor is activated by air pressure.

14. The sensor device of claim 2, wherein the sensor is activated by the inflation of a life jacket.
